(19) United States
(12) Patent Application Publication
(10) Pub. No.: US 2015/0006075 A1
(43) Pub. Date: Jan. 1, 2015

(54) Systems, Methods, and Computer-Readable Media for Determining a Parking Route Near a User's Destination

(71) Applicant: Google Inc., Mountain View, CA (US)

(72) Inventor: Ali Ajdari Rad, Zurich (CH)

(73) Assignee: Google Inc., Mountain View, CA (US)

(21) Appl. No.: 14/285,088

(22) Filed: May 22, 2014

Related U.S. Application Data
(60) Provisional application No. 61/840,154, filed on Jun. 27, 2013.

(51) Int. Cl. G08G 1/14

(52) U.S. Cl. CPC G08G 1/141
USPC 701/532; 701/540

(57) ABSTRACT

Provided are systems, methods, and computer-readable media routing users for determining a parking route near a user's destination. A request for parking near a destination and user parking criteria are obtained. A list of parking spaces based on the destination and near the user parking criteria are determined, and a parking route from the user's current location that traverses the list of parking spaces is also determined. The first portion of the parking route between the user's current location and the first parking space is determined. Additional portions of the parking route to additional parking spaces are provided until parking termination criteria are met.

### PRIORITY CLAIM

This application claims priority to U.S. Provisional Patent Application No. 61/840,154 filed on Jun. 27, 2013, entitled “Systems, Methods, and Computer-readable Media for Determining a Parking Route near a User's Destination”, the disclosure of which is hereby incorporated by reference in its entirety.

### BACKGROUND OF THE INVENTION

1. Field of the Invention

This invention relates generally to geographic data processing and, more particularly, to determining a parking route near a user's destination in a geographic area.

2. Description of the Related Art

Computer-implemented interactive maps are useful for a variety of purposes. For example, users may view interactive maps to learn about a geographic area, to identify the location of geographically-distributed objects (e.g., man-made structures or natural features) in a geographic area, search for categories of objects in a geographic area (e.g., restaurants in a given city), or identify routes between locations in a geographic area (e.g., driving directions from a current location to a desired destination). Typically, when using an interactive map, a user interacts with the map by viewing a particular geographic area or entering a destination to determine a route, and in some cases, receive navigation to the destination.

When traveling to a destination in a vehicle, a user may also desire to park the vehicle at or near the destination. However, parking data for a geographic area may be unavailable, incomplete, or inaccurate. Additionally, routes to existing parking may not result in the user finding a vacant parking space, as competition for parking spaces in the area may be relatively high. Further, a user may be unable to easily search for and locate additional parking spaces if initial routes to parking are unsuccessful.

### SUMMARY OF THE INVENTION

Various embodiments of systems, methods, and computer-readable media for determining a parking route are provided herein. In some embodiments, a computer-implemented method is provided that includes obtaining, via a processor, a parking request, including a destination and parking criteria, from a client device. Additionally, the method includes identifying at least one potential parking space based on information stored in a parking data repository and the parking criteria and providing information regarding a location of the at least one potential parking space to the client device.

In some embodiments, non-transitory tangible computer-readable storage medium having executable computer code stored thereon for determining a parking route is provided. The code includes a set of instructions that causes one or more processors to perform the following: obtaining, via a processor, a parking request, including a destination and parking criteria, from a client device. Additionally, the code includes a set of instructions that causes one or more processors to perform the following: identifying at least one potential parking space based on information stored in a parking data repository and the parking criteria and. providing information regarding a location of the at least one potential parking space to the client device.

Additionally, in some embodiments, a system for determining a parking route is provided. The system includes one or more processors and a tangible non-transitory memory accessible by the one or more processors, the memory having computer code stored thereon. The code includes a set of instructions that causes one or more processors to perform the following: obtaining, via the one or more processors, a parking request, including a destination and parking criteria, from a client device. Additionally, the code includes a set of instructions that causes one or more processors to perform the following: identifying at least one potential parking space based on information stored in a parking data repository and the parking criteria and. providing information regarding a location of the at least one potential parking space to the client device.

### BRIEF DESCRIPTION OF THE DRAWINGS

FIG. 1 is a block diagram of a process for determining parking near a destination in accordance with one or more embodiments of the present technique.

FIG. 2 is a block diagram of a process for routing users to parking near a destination in accordance with an embodiment of the present invention;

FIG. 3 is schematic diagram of a parking route in accordance with an embodiment of the present invention;

FIG. 4 is a schematic diagram of a system for determining routes to parking spaces in accordance with an embodiment of the present invention; and

FIG. 5 is a block diagram of a computer in accordance with an embodiment of the present invention; and

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION

As discussed in more detail below, provided in some embodiments are systems, methods, and computer-readable media for determining a parking route near a user's destination. A user submits a request for parking near a destination, such as by submitting the request to a maps application of vehicle navigation system. The user may also submit parking criteria, such as desired cost of the parking, duration of the parking, and distance from the destination. Parking data for a geographic region that includes the destination is obtained. The parking data includes the location of parking, the number of parking spaces, the cost of parking, the allowed duration of parking, and traffic information. Based on the parking criteria and the parking data, a list of potential parking spaces is determined. The list may be sorted by the distance of each parking space from the user's current location, the destination, or other sorting criteria. In some embodiments, the list of parking spaces is presented to the user, such as by displaying the parking spaces on a computer-implemented map. In some embodiments, the user can manually edit the list of parking spaces by deleting parking spaces they believe to be occupied or adding parking spaces they desire to include on the list.

After determining the list of potential parking spaces, a parking route between the user's current location that traverses through the list of parking spaces on the list is determined. The first portion of the parking route between the user's current location and a first parking space is provided to the user. If termination criteria are met, e.g., if the user parks, the parking route is terminated. If termination criteria are not met, e.g., if the user did not successfully park at the first parking space, then a next portion of the parking route between the first parking space and the next parking space on the list is provided to the user. In this manner, portions of the parking route between parking spaces are sequentially provided to the user for each parking space on the list until the termination criteria are met. Alternatively, the entire parking route may be provided to the user.

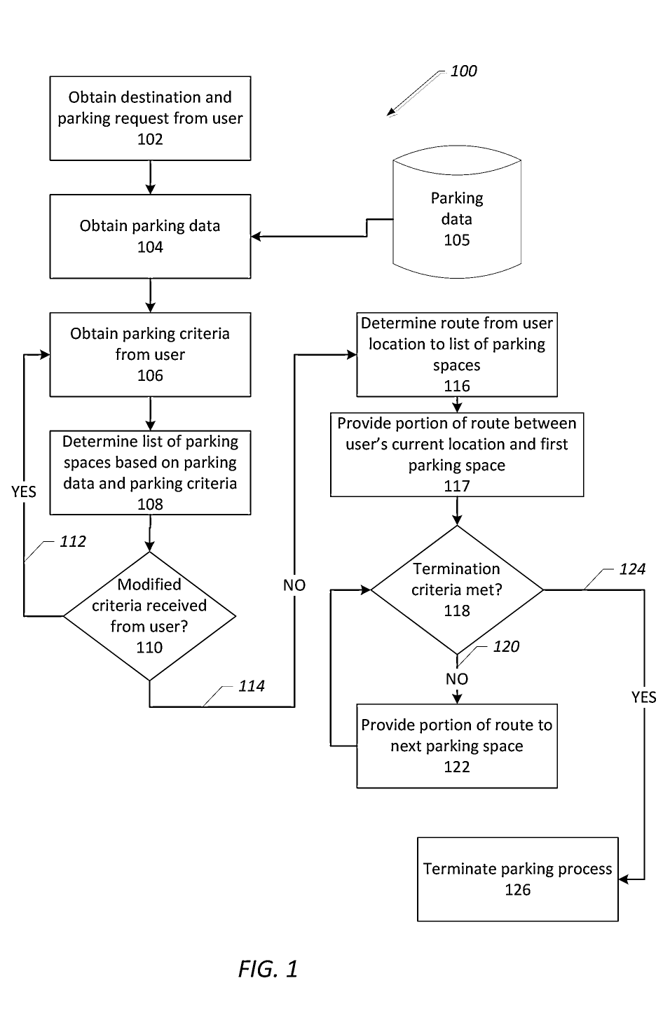

FIG. 1 is a block diagram depicting a process 100 for routing users to parking near a destination in accordance with an embodiment of the present invention. Initially, a destination and a request for parking near a destination are obtained from a user (block 102). For example, a user may enter a destination and a request for parking in a computer, such as smartphone or a vehicle navigation system. In some embodiments, a user request for parking may be implied from a user request for information about a destination, such as a request for driving directions. In such embodiments, the user need not explicitly request parking at the destination. Next, parking data is obtained (104) from a parking data repository 105. The parking data repository may be a database (e.g., one or more databases) of parking data for a geographic region. The parking data may include parking locations, the number of parking spaces, parking costs, allowed parking durations, traffic information, and any other data related to parking.

In some instances, parking criteria may be obtained from a user (block 106). For example, when entering a request for parking, a user may enter or be prompted to optionally enter additional parking criteria for parking Alternatively, the parking criteria may be specified in a user profile associated with the user. In some embodiments, the parking criteria may include desired parking cost, parking duration, and distance from the destination. Next, a list of potential parking spaces is determined from the parking data based on the parking criteria (block 108). In some embodiments, the potential parking spaces are sorted by sorting criteria, such as by cost, the distance from the user's current location or from the destination. In some embodiments, the list of parking spaces is provided to the user. In such embodiments, the user may manually edit the list of parking spaces to delete parking spaces from the list and add parking spaces to the list. For example, if the user knows a parking space on the list is no longer available, the user may delete the parking the space from the list. In some embodiments, the parking spaces may be provided to the user by displaying the location of the parking spaces on a computer-implemented map of a geographic area.

In some embodiments, modified parking criteria may be received from the user (decision block 110). For example, after viewing the list of potential parking spaces, the user may enter modified parking criteria, e.g., by changing existing criteria or adding new criteria. If the user enters modified parking criteria (line 112), then the modified parking criteria are obtained from the user (block 106) and a modified list of potential parking spaces is determined from the parking data based on the modified parking criteria (block 108).

If no modified criteria are received from the user (line 114), then a parking route from the user's current location that traverses through the parking spaces on the list is determined (block 116). In some embodiments, the entire parking route can be sent to the user. In other embodiments, only a portion of the parking route between the user's current location and the first potential parking space on the list is provided to the user to enable the user to navigate to the first potential parking space (block 117). When the user arrives at a potential parking space, the process determines whether termination criteria are met (block 118). The termination criteria may include, for example, an indication of successful parking received from the user, a cessation of vehicle movement correlated with a vehicle location at the potential parking space, a shutdown of the parking application, a shutdown of a navigation routine or mapping application, or other suitable termination criteria.

If the termination criteria are not met (line 120), then the next portion of the parking route between the current parking space and the next parking space on the list of potential parking spaces is provided to the user (block 122). In this manner, discrete portions of the parking route guiding the user to the next potential parking space on the list are provided until the termination criteria are met. If the termination criteria are met (line 124), then the parking process is terminated (block 126). In some embodiments, the occupancy of the parking space by the user may be provided to the parking data repository to update the parking data.

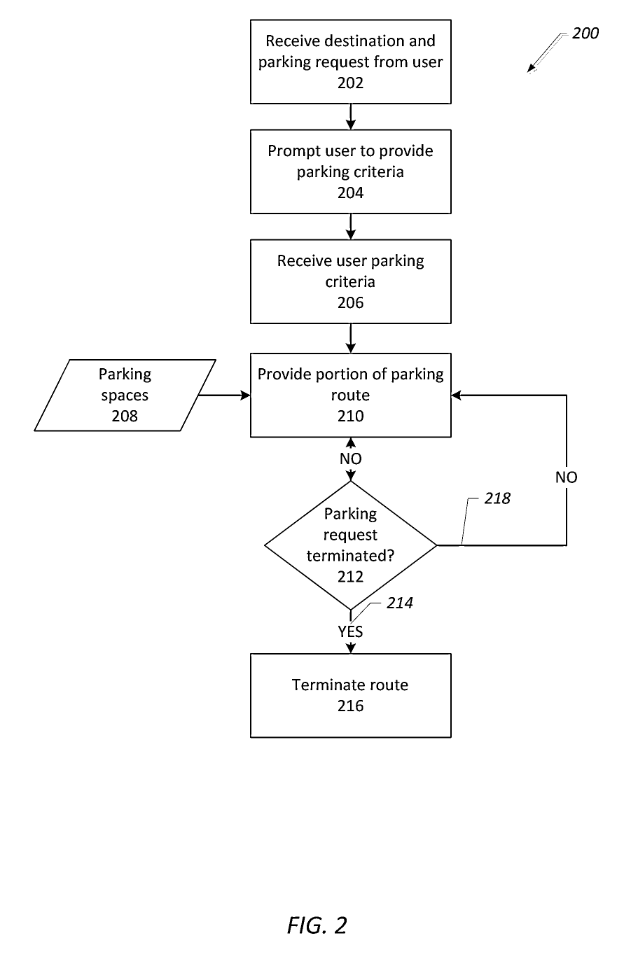

FIG. 2 depicts a process 200 for an application for routing users to parking near a destination in accordance with an embodiment of the present invention. Initially, a destination and a parking request are received from a user (block 202). For example, as stated above, a user may enter a destination and a parking request into a computer executing the application, such as a smartphone executing a maps application, a vehicle navigation system executing a navigation application, a standalone navigation system executing a navigation application, and the like. In some embodiments, a user parking request can be implied. For example, a user request for navigation to a destination can be interpreted to include an implied request for parking at the destination. Next, a user is optionally prompted to provide parking criteria (block 204). In some embodiments, the parking criteria may be provided with the request for parking or may be obtained from a user preferences file. The parking criteria are received from the user (block 206), and a list of potential parking spaces 208 and a parking route through those potential parking spaces is determined. Next, the parking route or a portion of the parking route that is between the user's current location and the first parking space on the list of parking spaces 208 is provided (block 210). As will be appreciated, the parking route may be based on geographic data available to the application, traffic information available to the application, and other data.

When the user reaches any one of the potential parking spaces in the list 208, the process 200 determines if the parking request has been terminated at that parking space (block 212). For example, if the user indicates he or she has found a parking space, turns off the parking application or a related mapping or navigation application, or the user's vehicle remains stationary at a potential parking space for more than a predetermined period of time, the parking request is considered terminated (line 214), and the parking route process is terminated (block 216). If, however, the parking request is not terminated at a current potential parking space (line 218), a portion of the parking route between the current parking space and the next parking space on the list is provided (block 210).

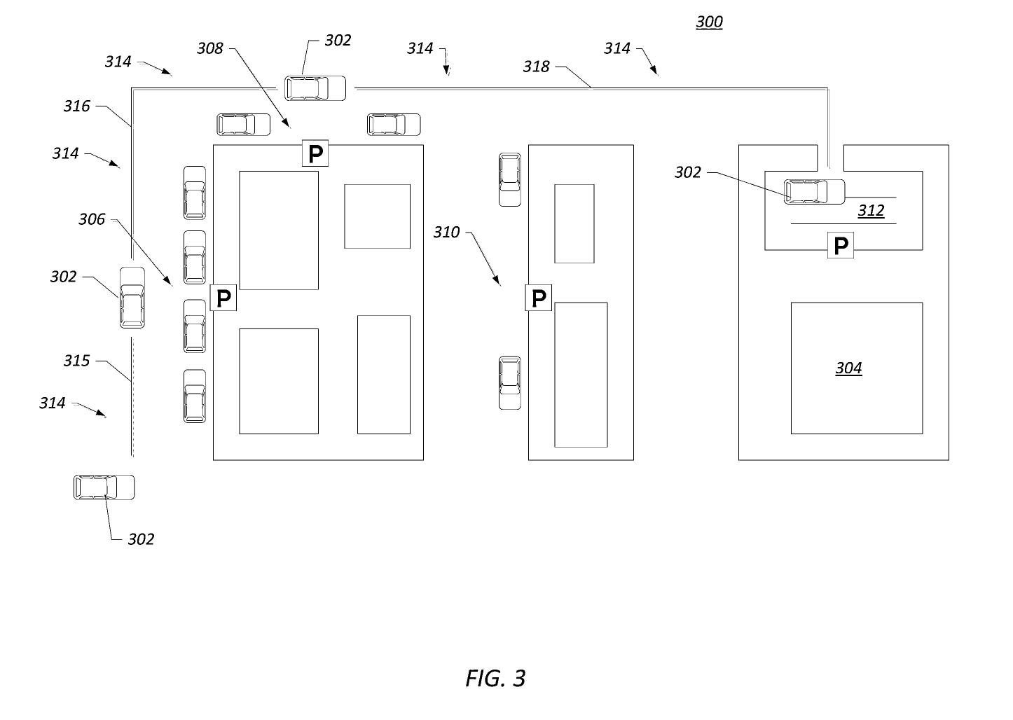

FIG. 3 depicts an example of a parking route provided in the manner described herein in accordance with an embodiment of the present invention. FIG. 3 depicts a map schematic 300 illustrating the route of a vehicle 302 looking for parking near a destination 304. Initially, as described above, a user may enter the destination 304 and implicitly or explicitly request parking near the destination 304. Additionally, as also described above, the user may enter parking criteria or parking criteria may be obtained from a user preference file. Based on the parking criteria and available parking data, a number of potential parking spaces are determined. For example, potential parking spaces 306, 308, and 312 are determined from the parking data and parking criteria. Although parking space 310 is potentially available, parking space 310 may not meet the user's parking criteria and thus is not included on the list of potential parking spaces.

As shown in FIG. 3, a parking route 314 is determined from the user's current location and traverses the potential parking spots 306, 308, and 312. In one embodiment, a first portion 315 of the parking route is provided between the user's current location, as indicated by vehicle 302, and the first parking space 306. The user may navigate the route 314 to arrive at the first potential parking space 306. However, as shown in FIG. 3, the first potential parking space 306 is occupied and the user is unable to park there. Thus, as described above, a second portion 316 of the parking route 314 is provided to the user between the first potential parking space 306 and the second potential parking space 308.

As shown in FIG. 3, the user may navigate the vehicle 302 along the route portion 316 to the second parking space 308. The user may decide not to park at the second parking space 308 for any of a variety of reasons, and continue to look for parking A third portion 318 of the parking route 314 is then provided to the user between the second potential parking space 308 and the third potential parking space 312. As shown in FIG. 3, the user may navigate the vehicle 302 to the third parking space 312, and park. Upon detecting a termination criteria (i.e., that the user has parked at parking space 312), the parking process is terminated and no further routing is provided to the user. As described above, the termination criteria may be user input indicating the user parked the vehicle 302 at the parking space 312, termination of the parking application or a related mapping or navigation application, or a determination that the vehicle 302 has remained at the parking space 312 for more than a predetermined period of time. After the termination criteria are met, the parking process terminates.

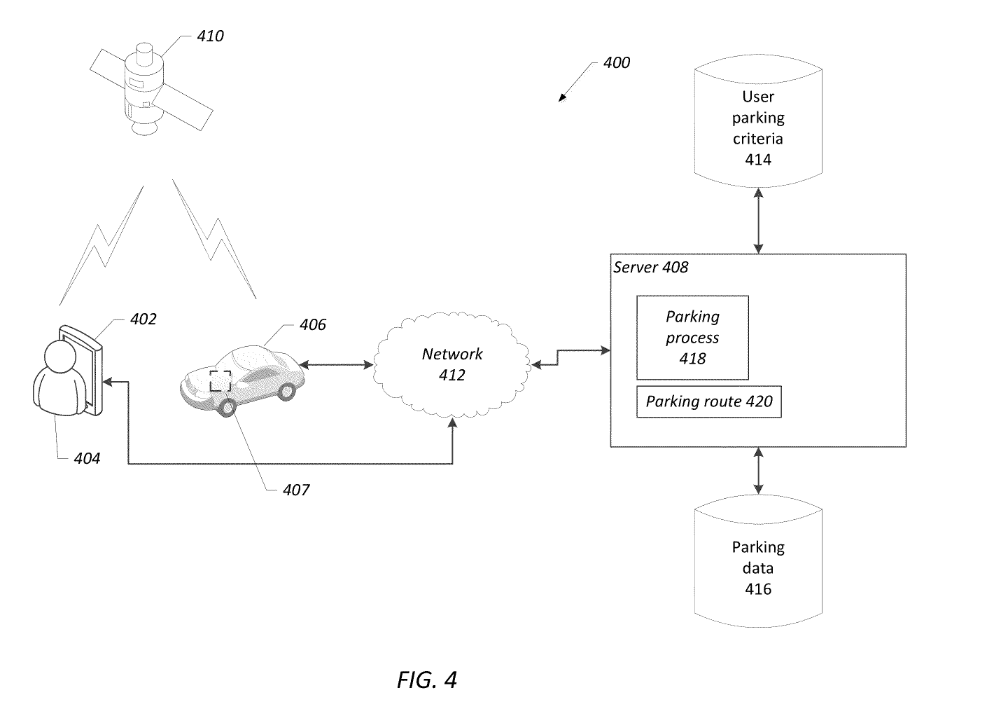

FIG. 4 depicts a system 400 for determining routes to parking spaces in accordance with an embodiment of the present invention. As shown in FIG. 4, the system 400 includes include a user 404 interacting with a computer, (e.g., a portable computer 402 or a vehicle navigation system 407), and a server 408. The portable computer 402 may include laptop computers, tablet computers, smartphones, personal digital assistants, standalone navigation systems, etc., and may include a receiver for a satellite-based navigation system 410, such as a Global Positioning System (GPS) receiver. The vehicle 406 may include automobiles, motorcycles, buses, commercial vehicles, or any other vehicles. The vehicle 406 may also include a computer, e.g., a vehicle navigation system 407, which may also include receivers for the satellite-based navigation system 410, such as GPS receivers. The vehicle navigation system 407 may be permanently integrated in the vehicle 406, or the system 407 may be a standalone (e.g., portable) navigation system removable from the vehicle 406. In some embodiments, a user in a vehicle (e.g., vehicle 406) may use a portable computer (e.g., portable computer 402), a vehicle navigation system (e.g., vehicle navigation system 407), or both to view interactive maps, find and input destinations, request parking, determine routes to parking spaces, and receive routes to parking spaces.

The portable computer 402, and/or the vehicle navigation system 407, are in communication with a network 412. As the portable computer 402 and/or the vehicle 406 traverse geographic areas, the position of the portable computer 402 and/or the vehicle navigation system 407 may be determined from the satellite-based navigation system 410. In some embodiments, the position of the portable computer and/or the vehicle navigation system 407 may instead be determined from communications with the network 412, such as from tokens obtained from the network (e.g., an IP address), signals received from the network (e.g., Wi-Fi signals, cell tower signals) and so on. The position may be stored on memories of the portable computer 402 and/or the vehicle navigation system 407 and, as described further below, may be transmitted over the network 412.

The network 412 may include multiple networks, such as a wireless Ethernet network, a cellular network, a local area network, a wide area network, or other types of networks. Moreover, the portable computer 402 and/or the vehicle navigation system 407, and the server 408 may each communicate over additional networks and different networks not shown in FIG. 4. For example, the portable computer 402 may communicate over a wireless Ethernet network, while the vehicle navigation system 407 communicates over a cellular network.

The server 408 may be a single server (in a discrete hardware component or as a virtual server) or multiple servers. The server 408 may include web servers, application servers, or other types of servers. Additionally, the server 408 may include, for example, computers arranged in any physical and virtual configuration, such as computers in one or more data processing centers, a distributed computing environment, or other configuration. Such configurations may use the network 412 for communication or may communicate over other networks. In some embodiments, the server 408 may be a part of a geographic information system (GIS).

The portable computer 402 and/or the vehicle navigation system 407 may transmit their present location, as determined via the satellite-based navigation system 410 or the network 412, to the server 408 for processing in accordance with the techniques described below. In some embodiments, the location of the portable computer 402 and/or the vehicle navigation system 407 may be determined with assistance of data received from the network 412, such as by assisted GPS (A-GPS). In other embodiments, the location of the portable computer 402 and/or the vehicle navigation system 407 may be determined solely from data received from the network 412. Moreover, as described further below, the vehicle location may be anonymized, either before or after transmission, so that vehicle locations are not associated with individual user identities or user devices (e.g., portable computers, vehicle navigation systems, etc.). Additionally, in some embodiments, the vehicle location data may not be collected at all, unless a user has expressly provided permission after receiving notice of the collection of such data and how it is used.

A user enters and request for parking using the portable computer 402 or the vehicle navigation system 407. As noted above, the request for parking may be implicit in a request for information about a destination, such as driving directions. The request for parking may include user parking criteria. The request is transmitted to the server 408 over the network 412 and, in some embodiments, the portable computer 402 or vehicle navigation system 407 may receive an acknowledgement of request from the server 408. Additionally, the portable computer 402 or vehicle navigation system 407 may transmit the current location of the computer 402 or system 407, as determined from the satellite positioning system 410 or the network 412.

In some embodiments, the portable computer 402 or the vehicle navigation system 407 may include a parking application (e.g., computer code stored on a computer-readable medium and having a set of instructions) that displays all or portions of a parking route received from the server 408 in response to the request for parking information. The parking application may also receive user requests for parking, user parking criteria, and perform other parking functions. The parking application may continue to display all or portions of a parking route until a parking process is terminated. In some embodiments, the parking application may be implemented within a maps or navigation application executed on the portable computer 402 or the vehicle navigation system 407.

The server 408 may include or have access to user parking criteria 414 and parking data 416. For example, in some embodiments the user parking criteria 414, the parking data 416, or both may be stored in a database (e.g., one or more databases) included in or accessible by the server 408. In some embodiments the user parking criteria 414 is transmitted from the computer 402 or the navigation system 407. In other embodiments, the user parking criteria 414 may be previously determined data that is associated with a user (e.g., in a user profile) and stored for later access. The parking data 416 includes parking data for a geographic region, such as the location of parking, the allowed duration of parking, the cost of parking, and other data.

The server 408 executes a parking process 418 to identify potential parking spaces, and determines a parking route 420 based on the potential parking spaces in accordance with the techniques described. Upon receiving the request for parking from the portable computer 402 or the vehicle navigation system 407, the parking process 418 evaluates the user parking criteria 414 and the parking data 416 to determine potential parking spots near the user's destination, as described above in FIG. 1. In some embodiments, as mentioned above, a list of potential parking spaces is transmitted to the client computer 402 or the navigation system 407 for viewing and/or editing by the user 404. In such embodiments, the user may edit the list of potential parking spaces (e.g., delete or add parking spaces), and the edited list may be transmitted over the network 412 to the server 408. After determining the list of potential parking spaces, a parking route is determined from the user's current location through the list of potential parking spaces, and the parking route 420 is provided to the client computer 402 or the navigation system 407 over the network 412. In some embodiments, only a first portion of the parking route 420 between the user's current location and the first parking space on the list of potential parking spaces is provided to the user via the client computer 402 or the navigation system 407. If the user does not park at the first or any given potential parking space, subsequent portions of the parking route 420 may be transmitted to the client computer 402 or the navigation system 407 providing the route from the current potential parking space to the next potential parking space on the list. The parking process 418 continues until termination criteria are met (e.g., a user indicates successful parking, the end of the list of parking spaces is reached, the vehicle 406 comes to rest at a potential parking space for a predetermined period of time, and so on). In some embodiments, additional requests for parking may be received from the client computer 402 or vehicle navigation system 407, such as, for example, when the user is unable to find available parking on the parking route first provided.

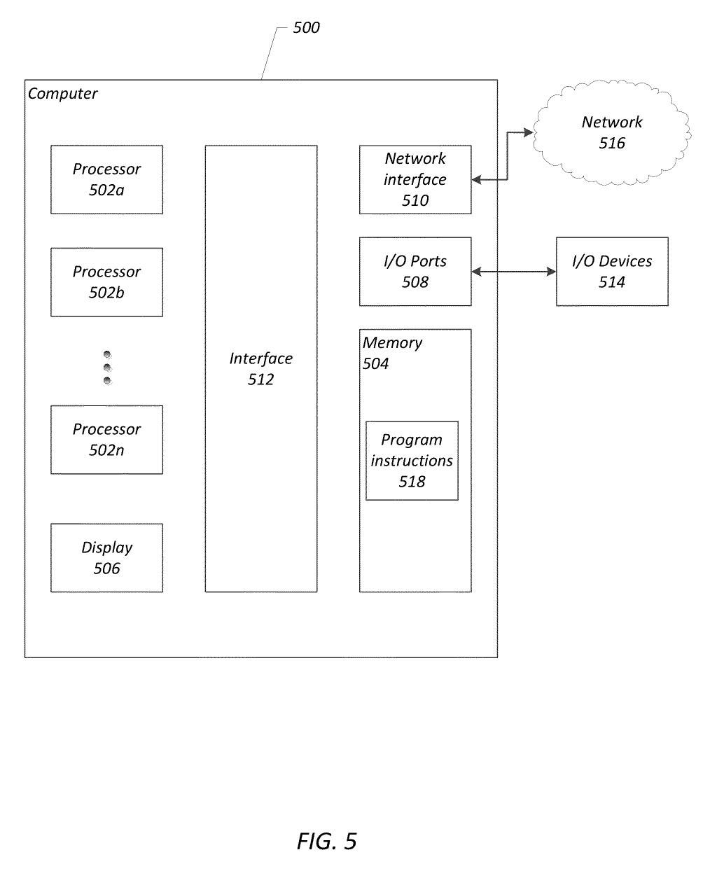

FIG. 5 depicts a computer 500 in accordance with an embodiment of the present invention. Various portions or sections of systems and methods described herein include or are executed on one or more computers similar to computer 500 and programmed as special-purpose machines executing some or all steps of processes described above as executable computer code. Further, processes, modules, and other components described herein may be executed by one or more processing systems similar to that of computer 500.

The computer 500 may include various components that contribute to the function of the device and enable the computer 500 to function in accordance with the techniques discussed herein. As will be appreciated, some components of computer 500 may be provided as internal or integral components of the computer 500 and some components may be provided as external or connectable components. Moreover, FIG. 5 depicts one example of a particular implementation and is intended to illustrate the types of components and functions that may be present in various embodiments of the computer 500.

Computer 500 may include a combination of devices or software that may perform or otherwise provide for the performance of the techniques described herein. For example, computer 500 may include or be a combination of a cloud-computing system, a data center, a server rack or other server enclosure, a server, a virtual server, a desktop computer, a laptop computer, a tablet computer, a mobile telephone, a personal digital assistant (PDA), a media player, a game console, a vehicle-mounted computer, or the like. The computer 500 may be a unified device providing any one of or a combination of the functionality of a media player, a cellular phone, a personal data organizer, a game console, and so forth. Computer 500 may be connected to other devices that are not illustrated or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available. As shown in the embodiment illustrated in FIG. 5, the computer 500 may include one or more processors (e.g., processors 502a-502n), a memory 504, a display 506, I/O ports 508 a network interface 510, and an interface 512. Additionally, the computer 500 may include or be coupled to I/O devices 514.

In addition, the computer 500 may allow a user to connect to and communicate through a network 516 (e.g., the Internet, a local area network, a wide area network, etc.) and, in some embodiments, to acquire data from a satellite-based positioning system (e.g., GPS). For example, the computer 500 may allow a user to communicate using e-mail, text messaging, instant messaging, or using other forms of electronic communication, and may allow a user to obtain the location of the device from a satellite-based positioning system.

In some embodiments, the display 506 may include a liquid crystal display (LCD) an organic light emitting diode (OLED) display, or other display types. The display 506 may display a user interface (e.g., a graphical user interface) executed by the processor 502 of the computer 500. The display 506 may also display various indicators to provide feedback to a user, such as power status, call status, memory status, network status etc. These indicators may be incorporated in the user interface displayed on the display 506. In some embodiments, the display 506 may include or be provided in conjunction with touch sensitive elements through which a user may interact with the user interface. In such embodiments, a touch-sensitive display may be referred to as a “touch screen” and may also be known as or called a touch-sensitive display system.

The processor 502 may provide the processing capability to execute the operating system, programs, user interface, and other functions of the computer 500. The processor 502 may include one or more processors and may include “general-purpose” microprocessors, special purpose microprocessors, such as application-specific integrated circuits (ASICs), or any combination thereof. In some embodiments, the processor 502 may include one or more reduced instruction set (RISC) processors, such as those implementing the Advanced RISC Machine (ARM) instruction set. Additionally, the processor 502 may include single-core processors and multicore processors and may include graphics processors, video processors, and related chip sets. Accordingly, the computer 500 may be a uni-processor system having one processor (e.g., processor 502a), or a multi-processor system having two or more suitable processors (e.g., 502a-502n). Multiple processors may be employed to provide for parallel or sequential execution of the techniques described herein. Processes, such as logic flows, described herein may be performed by the processor 502 executing one or more computer programs to perform functions by operating on input data and generating corresponding output. The processor 502 may receive instructions and data from a memory (e.g., system memory 504).

The memory 504 (which may include one or more tangible non-transitory computer readable storage mediums) may include volatile memory and non-volatile memory accessible by the processor 502 and other components of the computer 500. The memory 504 may store a variety of information and may be used for a variety of purposes. For example, the memory 504 may store executable computer code, such as the firmware for the computer 500, an operating system for the computer 500, and any other programs or other executable code for providing functions of the computer 500. Such executable computer code may include program instructions 518 executable by a processor (e.g., one or more of processors 502a-502n) to implement one or more embodiments of the present invention. Program instructions 518 may include modules of computer program instructions for implementing one or more techniques described herein. Program instructions 518 may include a computer program (which in certain forms is known as a program, software, software application, script, or code). A computer program may be written in a programming language, including compiled or interpreted languages, or declarative or procedural languages. A computer program may include a unit suitable for use in a computing environment, including a stand-alone program, a module, a component, a subroutine, and the like. A computer program may or may not correspond to a file in a file system. A computer program may be stored in a section of a file that holds other computer programs or data (e.g., one or more scripts stored in a markup language document), in a single file dedicated to the program in question, or in multiple coordinated files (e.g., files that store one or more modules, sub programs, or sections of code). A computer program may be deployed to be executed on one or more processors located locally at one site or distributed across multiple remote sites and interconnected by a communication network. Additionally, the memory 504 may be used for buffering or caching during operation of the computer 500.

As mentioned above, the memory 504 may include volatile memory, such as random access memory (RAM). The memory 504 may also include non-volatile memory, such as ROM, flash memory, a hard drive, other suitable optical, magnetic, or solid-state storage mediums or any combination thereof. The memory 504 may store data files such as media (e.g., music and video files), software (e.g., for implementing functions on computer 500), user preference information, payment transaction information, wireless connection information, contact information (e.g., an address book), and any other suitable data.

The interface 512 may include multiple interfaces and may enable communication between various components of the computer 500, the processor 502, and the memory 504. In some embodiments, the interface 512, the processor 502, memory 504, and one or more other components of the computer 500 may be implemented on a single chip, such as a system-on-a-chip (SOC). In other embodiments, these components, their functionalities, or both may be implemented on separate chips. The interface 512 may coordinate I/O traffic between processors 502a-502n, the memory 504, the network interface 510, I/O devices 514, or any other devices or a combination thereof. The interface 512 may perform protocol, timing or other data transformations to convert data signals from one component (e.g., the memory 504) into a format suitable for use by another component (e.g., processors 502a-502n). The interface 512 may implement various types of interfaces, such as Peripheral Component Interconnect (PCI) interfaces, the Universal Serial Bus (USB) interfaces, Thunderbolt interfaces, Firewire (IEEE-1394) interfaces, and so on.

The computer 500 may also include an input and output port 508 to enable connection of additional devices, such as I/O devices 514. Embodiments of the present invention may include any number of input and output ports 508, including headphone and headset jacks, universal serial bus (USB) ports, Firewire (IEEE-1394) ports, Thunderbolt ports, and AC and DC power connectors. Further, the computer 500 may use the input and output ports to connect to and send or receive data with any other device, such as other portable computers, personal computers, printers, etc.

The computer 500 depicted in FIG. 5 also includes a network interface 510. The network interface 510 may include a wired network interface card (NIC), a wireless (e.g., radio frequency) network interface card, or combination thereof. The network interface 510 may include known circuitry for receiving and sending signals to and from communications networks, such as an antenna system, an RF transceiver, an amplifier, a tuner, an oscillator, a digital signal processor, a modem, a subscriber identity module (SIM) card, memory, and so forth. The network interface 510 may communicate with networks (e.g., network 516), such as the Internet, an intranet, a cellular telephone network, a wide area network (WAN), a local area network (LAN), a metropolitan area network (MAN), or other devices by wired or wireless communication. The communication may use any suitable communications standard, protocol and technology, including Ethernet, Global System for Mobile Communications (GSM), Enhanced Data GSM Environment (EDGE), a 3G network (e.g., based upon the IMT-2000 standard), high-speed downlink packet access (HSDPA), wideband code division multiple access (W-CDMA), code division multiple access (CDMA), time division multiple access (TDMA), a 4G network (e.g., IMT Advanced, Long-Term Evolution Advanced (LTE Advanced), etc.), Bluetooth, Wireless Fidelity (Wi-Fi) (e.g., IEEE 802.11 standards), voice over Internet Protocol (VoIP), Wi-MAX, an email protocol (e.g., Internet message access protocol (IMAP) or post office protocol (POP)), message-oriented protocols (e.g., extensible messaging and presence protocol (XMPP), Multimedia Messaging Service (MMS), Short Message Service (SMS), or any other suitable communications standards, protocols, and technologies.

Various embodiments may further include receiving, sending or storing instructions and/or data implemented in accordance with the foregoing description upon a computer-accessible medium. Generally speaking, a computer-accessible/readable storage medium may include a non-transitory storage media such as magnetic or optical media, (e.g., disk or DVD/CD-ROM), volatile or non-volatile media such as RAM (e.g. SDRAM, DDR, RDRAM, SRAM, etc.), ROM, etc.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” mean including, but not limited to. As used throughout this application, the singular forms “a”, “an” and “the” include plural referents unless the content clearly indicates otherwise. Thus, for example, reference to “an element” includes a combination of two or more elements. Unless specifically stated otherwise, as apparent from the discussion, it is appreciated that throughout this specification discussions utilizing terms such as “processing”, “computing”, “calculating”, “determining” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical electronic or magnetic quantities within memories, registers, or other information storage devices, transmission devices, or display devices of the special purpose computer or similar special purpose electronic processing/computing device.

What is claimed is:

1. A computer-implemented method for identifying a parking space, the method comprising:
obtaining, via a processor, a parking request, including a destination and parking criteria, from a client device;
identifying at least one potential parking space based on information stored in a parking data repository and the parking criteria; and
providing information regarding a location of the at least one potential parking space to the client device.

2. The method of claim 1, wherein a plurality of parking spaces are identified, further comprising providing the client device a map showing the location of the plurality of parking spaces.

3. The method of claim 1, wherein a plurality of parking spaces are identified, further comprising:
receiving a current location of the client device;
determining a parking route from the current location of the client device that traverses each of the plurality of parking spaces; and
providing at least a first portion of the parking route between the current location of the client device and a first potential parking space of the plurality of parking spaces.

4. The method of claim 3, further comprising:
determining whether parking termination criteria are met at the first potential parking space: and
providing at least a second portion of the parking route between the first potential parking space and a second potential parking space of the plurality of parking spaces if the termination criteria are not met.

5. The computer-implemented method of claim 1, wherein the parking criteria include at least one of a cost of a parking space, an expected duration at a parking space, or a distance between a parking space and the destination.

6. The computer-implemented method of claim 4, wherein the termination criteria include at least one of an indication of successful parking received from the client device, a termination of a parking process, a termination of a mapping or navigational process associated with the parking process, or an indication that the client device is located at the first potential parking space and has not moved for more than a predetermined period of time.

7. A non-transitory tangible computer-readable storage medium having executable computer code stored thereon for identifying a parking space, the code comprising a set of instructions that causes one or more processors to perform the following:
obtaining, via a processor, a parking request, including a destination and parking criteria, from a client device;
identifying at least one potential parking spaces based on information stored in a parking data repository and the parking criteria; and
providing information regarding a location of the at least one potential parking space to the client device.

8. The non-transitory tangible computer-readable storage of claim 7, wherein a plurality of parking spaces are identified, further comprising providing the client device a map showing the location of the plurality of parking spaces.

9. The non-transitory tangible computer-readable storage of claim 7, wherein a plurality of parking spaces are identified, the code further comprising a set of instructions that causes one or more processors to perform the following:
receiving a current location of the client device;
determining a parking route from the current location of the client device that traverses each parking space of the plurality of parking spaces; and
providing at least a first portion of the parking route between the current location of the client device and a first potential parking space of the plurality of parking spaces.

10. The non-transitory tangible computer-readable storage of claim 9, the code further comprising a set of instructions that causes one or more processors to perform the following:
determining whether parking termination criteria are met at the first potential parking space: and
providing at least a second portion of the parking route between the first potential parking space of the plurality of parking spaces and a second potential parking space of the plurality of parking spaces if the termination criteria are not met

11. The non-transitory tangible computer-readable storage of claim 7, wherein the parking criteria include at least one of: a cost of a parking space, an expected duration at a parking space or a distance between a parking space and the destination.

12. The non-transitory tangible computer-readable storage of claim 11, wherein the termination criteria comprising include at least one of an indication of successful parking received from a user the client device, a termination of a parking process, a termination of a mapping or navigational process associated with the parking process, or an indication that the client device is located at the first potential parking space and has not moved for more than a predetermined period of time cessation of vehicle movement correlated with a vehicle location at the parking space.

13. A system for identifying a parking space, the system comprising:
one or more processors;
a tangible non-transitory memory accessible by the one or more processors, the memory having computer code stored thereon, the code comprising a set of instructions that causes one or more processors to perform the following:
obtaining, via the one or more processors, a parking request, including a destination and parking criteria from a client device;
identifying at least one potential parking spaces based on information stored in a parking data repository and the parking criteria; and
providing information regarding a location of the at least one potential parking space to the client device.

14. The system of claim 13, wherein a plurality of parking spaces are identified, further comprising providing the client device a map showing the location of the plurality of parking spaces.

15. The system of claim 13, wherein a plurality of parking spaces are identified, the code further comprising a set of instructions that causes one or more processors to perform the following:
receiving a current location of the client device;
determining a parking route from the current location of the client device that traverses each parking space of the plurality of parking spaces; and
providing at least a first portion of the parking route between the current location of the client device and a first potential parking space of the plurality of parking spaces.

16. The system of claim 15, the code further comprising a set of instructions that causes one or more processors to perform the following:
determining whether parking termination criteria are met at the first potential parking space: and
providing at least a second portion of the parking route between the first potential parking space of the plurality of parking spaces and a second potential parking space of the plurality of parking spaces if the termination criteria are not met.

17. The system of claim 13, wherein the parking criteria include at least one of: a cost associated with of a parking space, an expected duration associated with at a parking space, and or a distance between a parking space and the destination.

18. The system of claim 17, wherein the termination criteria comprising include at least one of an indication of successful parking received from a user the client device, a termination of the parking process, a termination of a mapping or navigational process associated with the parking process, or an indication that the client device is located at the first potential parking space and has not moved for more than a predetermined period of time.
